(19) United States
(12) Patent Application Publication
(10) Pub. No.: US 2009/0026755 A1
(43) Pub. Date: Jan. 29, 2009

(54) Drawing label

(76) Inventor: Gale Schmidt, Portland, OR (US)

Correspondence Address: Gale Schmidt, 5311 NE 105th Ave., Portland, OR, 97220, US

(21) Appl. No.: 11/881,616

(22) Filed: Jul. 28, 2007

(51) Int. Cl. B42D 15/00

(52) U.S. Cl. 283/81

(57) ABSTRACT

The present invention is a novel and unique label that is for use with layered or rolled papers, sheets or films that has a leading edge (tongue) that penetrates the sheets and has a writing surface (face) that is angular to the tongue.

### CROSS-REFERENCE TO RELATED APPLICATION

Not Applicable

### STATEMENT OF GOVERNMENT SPONSORED DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC

Not Applicable

### FIELD OF INVENTION

This invention relates to labels to identify products, and in particular, to labels for layered sheets as in rolled drawings, stacks of papers or other sheet goods, book pages, etc. where the label is perpendicular to the sheet goods and is applied to the edges of the sheets and is removable and reusable.

### BACKGROUND OF THE INVENTION

One of the challenges of any office environment is to stay organized and be able to find things quickly. A well-designed label or tag facilitates finding the relevant document, drawing, file, or record easily and quickly. For example, vertical and hanging file folders have appended labels oriented toward the top to facilitate a quick scan by a person opening the drawer. File cabinets include external vertical labels to identify the contents of each drawer. Individual sheets or stacks of papers have stick-on notes to aid the filing person identify its contents. In fact, the prior art provides ample examples of various label devices adapted for pretty much any flat, vertical surface. However, there is no label device for edges of sheets such as rolled drawings or stacks of paper or other sheet goods. The present invention, called a drawing label, specifically addresses this problem.

Generally, the surfaces or edges of rolled drawings are uneven and not suitable for labels such as “Post it” brand notes (available from 3M Corporation) or other self adhering labels because such self-adhesive labels fall off easily. Known labels placed on the outer surface of a rolled drawing can not be easily seen especially if multiple drawings are stored together on shelves or in bins. In the case of stacked sheet goods the edges are the most visible surface yet conventional labels do not adhere to edges. What was needed was a label that could be seen on the end of rolled drawings or stacks of sheet goods, stay in place and be viewed easily.

The present invention overcomes the shortcomings of the prior art label devices. Further, in one embodiment, the present invention is thin yet rigid and consists of a sign portion (face) and an attachment portion (tongue) that are angular to each other. The tongue will easily slip between sheets of papers or other sheet goods and stay in place, and the face will be at about a 90-degree arrangement with respect to the tongue, which provides a highly visible sign area The sign area (face) can be written on by hand or may be used as a backer to hold self adhering labels. As a backer, the drawing label can be used repeatedly.

Traditional prior art labels deal with flat surfaces only. U.S. Pat. No. 5,770,288 issued to Carney, Jr., on 23 Jun. 1998 is an adhesive-backed label suitable for applying to flat surfaces. Thus it can be seen only on the surface of the material it is applied to. The current invention, drawing label, is angular and when applied by inserting the tongue portion between sheets, the label portion is visible perpendicular to the sheet face. The drawing label specifically addresses the condition of ends of sheets and/or rolled goods. Its method of adherence is through friction and the weight of the material above it.

### SUMMARY OF THE INVENTION

A label wherein the body or “sign” area is angled to the application portion (tongue). The tongue is of a slight size that allows it to slip between sheets of paper or films while the “sign” portion is larger for annotating information. The sign portion may also be used as a backer to apply conventional self-adhering labels thus making the drawing label reusable.

### Advantages of the Present Invention

The angular label allows layered or rolled sheet items to be easily identified, marked and organized. It provides for a “sign” to be applied in the most easily recognizable area—the exposed edges of sheets or rolls.

### BRIEF DESCRIPTION OF THE DRAWINGS

FIG. 1 is a representative view of the applied label to rolled paper sheets

FIG. 2 is a representative view of the applied label to a stack of sheets or book pages

FIG. 3 is a perspective view of the present invention label which has an attachment portion (tongue) 2 and a sign portion 1

FIG. 4 is the front elevation view of the label showing the face surface 1 for writing on or adhering conventional labels

FIG. 5 is the top or plan view of the label showing the attachment, or “tongue” portion of the label

FIG. 6 is the side elevation view of the label

FIG. 7 is a representative view of the label with alternative tongue portion

FIG. 8 is a layout of material sheets with a die cutting pattern

### DETAILED DESCRIPTION OF THE PREFERRED EMBODIMENTS

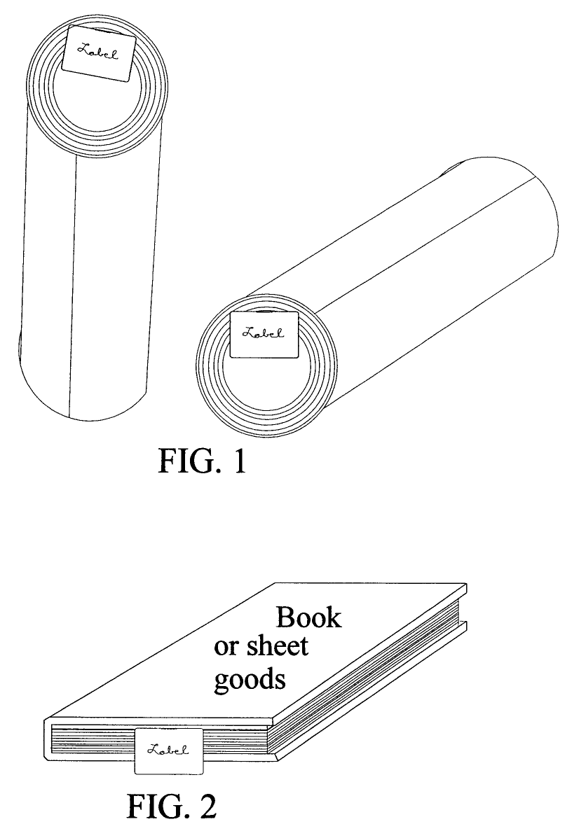

FIG. 1 shows the drawing label attached to a rolled paper drawing in one of its preferred applications. As can be seen the label face is visible while the tongue is hidden as it is penetrated in between the paper sheets.

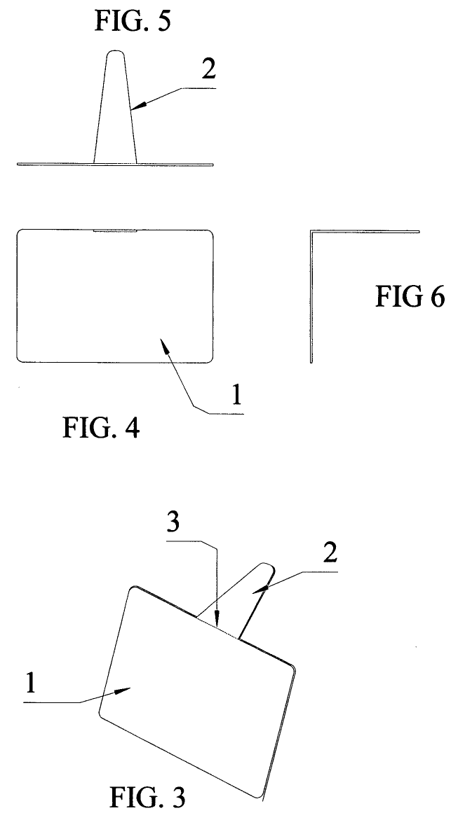

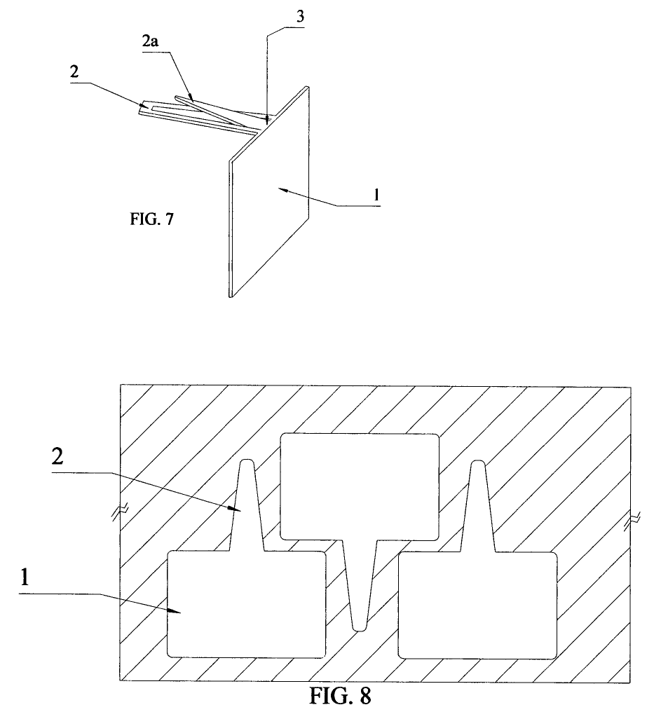

Referring to FIGS. 2, 3 and 4 the drawing label includes a face 1, tongue 2 and a fold line 3.

In the preferred form the whole label is made of a polycarbonate, vinyl, or plastic-type material that is die-cut from flat sheets. The preferred form is 10 to 15 mil thickness to provide rigidity, fold retention, and still have a thin profile for slipping between sheets. The face area 1 is for annotating descriptive information. As an alternative to annotating the label, the label face may be used as a backer to accept self adhesive labels. Thus self-adhesive labels may be printed independently of the drawing label and applied at any time. The label face may be made in colors to add visibility to the label.

The tongue 2 of the label is narrower than the body and is inserted between sheets and held in place by friction and the weight of the sheets. The tongue 2 is bent on the fold line 3 to form an angled part. The preferred angle is 90 degrees to the face 1 but may be modified by the user. The tongue 2 is inserted between sheets in stacks or rolls. The tongue is formed in a triangular shape with the apex to the outside. The narrow apex allows the tongue to penetrate sheets easily. The broader base of the tongue increases the surface area of the tongue and increases the holding power of the label.

FIG. 7 illustrates an alternative embodiment of the drawing label of the present invention and its use to provide a clipable form of the label. This embodiment of the drawing label is similar to that described with a writable face and a tongue attachment method, however, here the tongue portion is slotted to allow the tongue to separate into an outer portion 2 and an inner portion 2a. Thus the outer and inner portions of the tongue can be scissored and positioned alternately above and below a sheet(s) of material providing a gripping method. This allows the drawing label to be used where little friction exists as in upright files or loosely rolled sheets.

With reference to FIG. 8, multiple drawing labels can be manufactured in a die-cut process. A die can be made to cut multiple parts out of sheet stock. As the parts may be offered in colors or imprinted the coloring process can happen prior to the cutting of the parts.

While there has been shown and described what are at present considered to be the preferred embodiments of the invention, it will be obvious to those skilled in the art that various changes and modifications can be made to the described device without departing from the scope of the present invention. For example, other materials such as composite papers or films or other processes such as injection molding can be used to replicate the form and function of the part. Accordingly, to ascertain the full scope of the invention, reference must be made to the following claims.

What is claimed is:

1. A label for attaching to sheet goods, said label comprising: a face portion for the purpose of adding descriptive information and a tongue portion disposed at an angle to the face for attaching to sheet materials.

2. The label of claim 1, wherein the face comprises a surface adapted for use as a writing surface.

3. The label of claim 1 wherein the face comprises a surface adapted for use as a backer for self-adhering labels.

4. The label of claim 1 further comprising an attachment portion means comprising a tongue disposed adjacent to the face and further the tongue being adapted for use as an attaching means to the sheet goods.

5. The label of claim 4 wherein the attachment portion comprises a smooth and tapered appendage.

6. The label of claim 4 wherein the attachment portion, further comprises to form a gripping element whereby the attachment portion separates in a scissor-effect to grip the sheet goods.

7. The label of claim 1 wherein the label is of a size convenient for notating and viewing. A variety of sizes are anticipated.

8. The label of claim 1 wherein the device is variously colored or imprinted with designs and/or text.

9. A label device comprising:
a face portion and a tongue portion disposed at about a 90-angle relative to the face portion;
the face portion further comprising a surface adapted for use as a writing surface or a backer;
the tongue portion comprising a smooth and tapered appendage; and the tongue portion further comprising a gripping element arranged at a distal end, the gripping element adapted to separate.
